(19) United States
(12) Patent Application Publication
(10) Pub. No.: US 2012/0070721 A1
(43) Pub. Date: Mar. 22, 2012

(54) LITHIUM ION BATTERY

(76) Inventors: Lei HAN, Shenzhen (CN); Xian Kai Zhou, Shenzhen (CN); Jia Yao, Shenzhen (CN)

(21) Appl. No.: 13/307,614

(22) Filed: Nov. 30, 2011

Related U.S. Application Data
(63) Continuation of application No. PCT/CN2010/072383, filed on Apr. 30, 2010.

(30) Foreign Application Priority Data
May 31, 2009 (CN) 200920132514.7

(51) Int. Cl. H01M 2/02

(52) U.S. Cl. 429/163

(57) ABSTRACT

The present disclosure discloses a lithium ion battery comprising a battery shell, a cover assembly, an electrode assembly, a first current collecting plate and a second current collecting plate. The electrode assembly comprises a positive plate, a negative plate and a separator provided therebetween which are coiled together. The electrode assembly and the current collecting plates are disposed in a space formed by the battery shell and the cover assembly. The first and second current collecting plates are disposed at each end of the electrode assembly respectively, with a first uncoated area of the positive plate and a second uncoated area of the negative plate being welded to the first and second current collecting plates respectively.

### CROSS-REFERENCE TO RELATED APPLICATION

The present application is a continuation of International Application No. PCT/CN2010/072383, filed Apr. 30, 2010, designating the United States of America, which claims priority of Chinese Patent Application No. 200920132514.7, filed with SIPO on May 31, 2009, the entirety of both of which are hereby incorporated by reference.

### FIELD OF THE INVENTION

The present disclosure relates to the field of lithium ion batteries, more particularly to a lithium ion battery having a current collecting plate.

### BACKGROUND OF THE INVENTION

In recent years, battery driven equipments such as power tools, electric toys, model aircrafts and electric vehicles are springing up rapidly. Accordingly, requirements for high-rate charging and discharging performance of the secondary battery are growing. Lithium ion batteries are widely used because of the advantages such as high power output, high energy density, high working voltage, low self-discharge, wide application, stable working voltage, and long storage lifespan. Currently, conventional lithium ion batteries with coiled core mainly adopt a single tab or a plurality of tabs to collect current, limiting current conducting on certain welding spots with dissatisfactory conducting performance. Also the internal resistance may be high; during charging or discharging, the current distribution may not be uniform, making it difficult to realize large-current charging or discharging. Besides, during large-current discharging, because of the high internal resistance, the battery may emit heat and the temperature of the battery may get very high. Therefore, it is one of the research hotspots to enhance the large-current charging and discharging performance of the lithium ion secondary battery nowadays. Most of the researches are focusing on enhancing the large-current charging and discharging performance of the positive active material, negative active material and electrolyte of the lithium ion battery, and certain result has been achieved. However, the power characteristics are still restricting the application of lithium ion batteries in the power battery field. Other methods like providing current collecting plates on both ends of the electrode assembly have also been adopted.

Chinese Patent Application CN200510087347 discloses an electrode assembly, of which the end faces comprise a pair of parallel cuts, and the tabs between the cuts bend toward the central opening of the electrode assembly such that a groove is formed at the bent area of the tabs. A current collecting plate is electrically connected to the bent area. The current collecting method may increase the welding strength between the current collecting plate and the end faces of the electrode assembly, and reduce the internal resistance of the battery. Nevertheless, as the current collecting plate and the electrode assembly are welded only at limited spots, the current conducting surface of the welding spots is smaller than that of the blank current collector in the electrode assembly. And current collecting may not be uniform in the wounding direction, as the welding area does not vary along the radius direction of the electrode assembly. Meanwhile as the current collector needs to be cut, the preparation process may be complex and may produce metal burrs or scraps with hidden safety problems. Besides, the tab bending structure may require certain height of the blank current collector to be reserved in the design of the electrode assembly, which may decrease the capacity of the battery. Therefore, the current collecting structure of the end face needs to be improved so that it may increase the welding strength and also the current conducting surface of the end face. Meanwhile, current collecting uniformity of the electrode assembly needs to be improved so as to enhance the high-current charging and discharging performance of the battery.

### SUMMARY OF THE INVENTION

The present disclosure provides a lithium ion battery that may have uniform current collecting property with excellent discharging performance.

According to one aspect of the disclosure, a lithium ion battery may be provided, comprising: a battery shell; a cover assembly sealing an open end of the battery shell; an electrode assembly comprising a positive plate, a negative plate and a separator in between which are coiled together, the positive plate comprising a first coated area and a first uncoated area adjoining the first coated area along a longitudinal direction of the battery, the negative plate comprising a second coated area and a second uncoated area adjoining the second coated area along the longitudinal direction of the battery, with the second uncoated area opposing to the first uncoated area; a first current collecting plate; and a second current collecting plate. The electrode assembly and the current collecting plates may be disposed in a space formed by the battery shell and the cover assembly. The first and second current collecting plates may be disposed at each end of the electrode assembly respectively, with the first and second uncoated areas being welded to the first and second current collecting plates respectively.

The solution in the present disclosure may have the following advantages:

1. The conducting surfaces between the electrode assembly and the current collecting plates are increased, and the internal resistance of the battery is decreased accordingly.

2. The uncoated areas, i.e. the tabs, of the battery may not need to bend, enabling the use of any pattern of the welding trace rather than only the cross shaped welding area. And the molten connection between the tabs and the current collecting plates ensures the welding strength.

3. Current collecting areas are increased, and the high-current discharge performance may be enhanced because of the welding structure adopted herein.

4. The uncoated areas, i.e., the tabs, of the battery may not need to bend or be cut, which may, to a great extent, decrease the possibility of damaging the tabs and also limit the unwanted effects of metal scraps produced during cutting. The battery safety performance may be improved, and the manufacturing process may be simplified.

### BRIEF DESCRIPTION OF THE DRAWINGS

These and other aspects and advantages of the invention will become apparent and more readily appreciated from the following descriptions taken in conjunction with the drawings in which:

FIG. 1 shows a schematic cross sectional view of a lithium ion battery according to an embodiment of the present disclosure;

FIG. 2 shows a schematic view of the winding of an electrode assembly according to an embodiment of the present disclosure;

FIG. 3(a) and FIG. 3(b) show a schematic view of a current collecting plate according to an embodiment of the present disclosure;

FIG. 4(a) shows a schematic view of a welding structure between an end surface of an electrode assembly and a current collecting plate according to an embodiment of the present disclosure;

FIG. 4(b) shows a schematic view of a welding trace pattern after an end surface of an electrode assembly is welded with a current collecting plate according to an embodiment of the present disclosure;

FIG. 4(c) shows a schematic view of a welding trace pattern after an end surface of an electrode assembly is welded with a current collecting plate according to another embodiment of the present disclosure; and

FIG. 5 shows a current collecting effect of a positive plate according to an embodiment of the present disclosure.

### DETAILED DESCRIPTION OF THE EMBODIMENTS

These and other aspects, solutions and advantages of the invention will become apparent and more readily appreciated from the following descriptions taken in conjunction with the drawings, and the embodiments should be considered as an explanation instead of limitation to the invention.

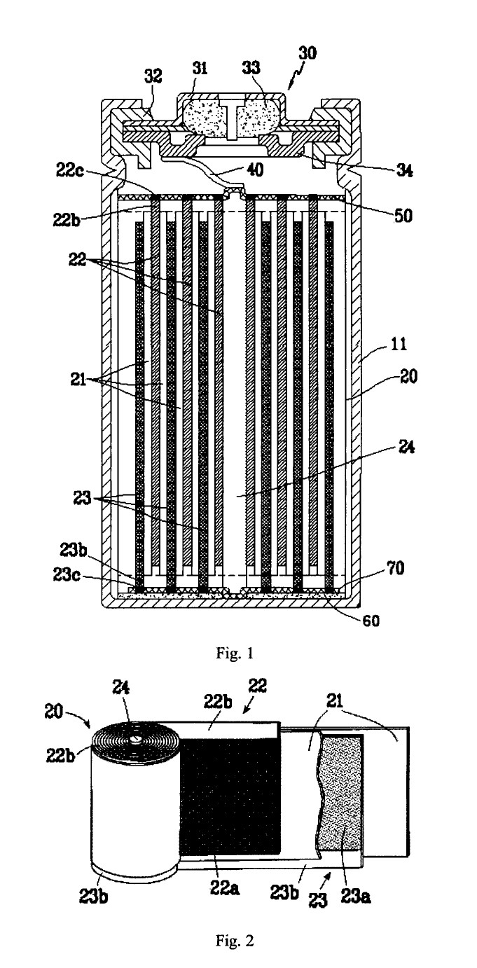

As shown in FIG. 1, a lithium ion battery according to one embodiment of the present disclosure may comprise a battery shell 11, a cover assembly 30 sealing an open end of the battery shell 11, an electrode assembly 20 and current collecting plates 50, 70. The electrode assembly 20 and the current collecting plates 50, 70 may be disposed in a space formed by the battery shell 11 and the cover assembly 30. The electrode assembly 20 may be formed by coiling electrode plates with a separator 21. The electrode plates may comprise a positive plate 22 and a negative plate 23, and the separator 21 may be disposed between the positive plate 22 and the negative plate 23. The positive plate 22 and the negative plate 23 may comprise a coated area 22a, 23a and an uncoated area 22b, 23b along the length direction of the electrode plates respectively. The uncoated areas 22b, 23b of the positive plate 22 and the negative plate 23 may be placed oppositely to each other and extend out from both ends of the electrode assembly 20 to serve as two end faces of the electrode assembly 20, with the uncoated areas 22b, 23b being welded to the current collecting plates 50, 70 respectively. The two current collecting plates 50, 70 may be disposed at the two ends of the electrode assembly 20 respectively. And the two end faces of the electrode assembly 20 may be welded with the current collecting plates 50, 70.

The battery shell 11 may be made of steel or aluminum, and it may be formed as cylindrical, square or other shapes; in the present embodiment, a cylindrical shape is described for illustration purposes.

The electrode assembly 20 will be described in detail.

If the uncoated area of the electrode plate is too wide, it may easily bend and affect the welding effect of the end surface of the electrode assembly. Therefore, according to some embodiments, the width of the uncoated area may range from about 2 mm to 10 mm, more preferably from 3 mm to 5 mm. Besides, to avoid laser beam damage to the coated area of the electrode plate, according to some embodiments, a joint between the coated area and the uncoated area of the electrode plate may be adhered with an adhesive tape at both faces of the electrode plate along the wounding direction of the electrode plate. It may be easy to understand that the width of the adhesive tape may not be restricted, providing that the edges of the tape do not extend beyond the border of the uncoated area. Or the adhesive tape may be adhered on both faces of the uncoated area of the electrode plate, the adhesive tape having a width not larger than that of the uncoated area in the longitudinal direction of the battery with a lower edge of the tape being adhered to the coated area. The above mentioned adhesive tapes may be made of heat-resistant and electrolyte resistant material.

As shown in FIGS. 1 and 2, for clarity purposes, the coated area and the uncoated area on the positive plate 22 are referred to as the positive coated area 22a and the positive uncoated area 22b respectively. And the coated area and the uncoated area on the negative plate 23 are referred to as the negative coated area 23a and the negative uncoated area 23b respectively.

The positive plate 22, the negative plate 23 and the separator 21 may be wound to form the electrode assembly 20. While wounding, the uncoated area 22b of the positive plate 22 may be placed upwards, and the uncoated area 23b of the negative plate 23 may be placed downwards. The positive plate 22 and the negative plate 23 may be staggered by a certain distance along the height direction, i.e. the longitudinal direction, of the battery and then wound onto a core rod 24. The separator 21 may be placed between the positive plate 22 and the negative plate 23. The upper end and the lower end of the electrode assembly 20 may, respectively, expose the uncoated area 22b of the positive plate 22 and the uncoated area 23b of the negative plate 23 to form an upper flat end surface and a lower flat end surface respectively. The matching between the core rod 24 and the current collecting plates 50, 70 may increase the connection strength between the current collecting plates 50, 70 and the electrode assembly 20, and provide a protruding portion for convenient connection with the cover assembly. Moreover, the existence of the core rod 24 may ensure the tightness and evenness of the coiling structure. Meanwhile, the electrode assembly 20 with the core rod 24 may easily be held for welding the end surface. The core rod 24 may be an insulator.

The coated area 22a of the positive plate 22 may be formed by uniformly coating a positive slurry onto a positive current collecting portion; the uncoated area 22b of the positive plate 22 may be formed by reserving a blank area with a certain width before coating or by removing the coated material with a certain width along a width direction of the positive plate 22. The uncoated area 22b may serve as a positive tab, and the positive tab may have the same length of the positive plate 22.

The positive plate 22 may be made of aluminum foil, copper foil, nickel plated steel strips or punched steel strips. The positive slurry may comprise a positive active material, a binding agent and a solvent. And there is no special limit for the positive active material. It may be chosen from any conventional positive active material used in lithium ion batteries. For example, it may include one or more selected from lithium cobalt oxide, lithium nickel oxide, lithium manganese oxide, lithium iron phosphate and lithium nickel manganese oxide.

There is no special limit for the binding agent in the positive slurry, the type or dosage of which may be known in the art. According to some embodiments of the present disclosure, the binding agent may include fluorine-containing resins and/or polyolefin compounds; for example, it may include one or more selected from polyvinylidene chloride (PVDF), polytetrafluorethylene (PTFE) and styrene-butadiene rubber (SBR). Commonly, the content of the binding agent in the positive slurry may range from 0.01 wt % to 8 wt % of the positive active material; according to a preferred embodiment, the content of the binding agent in the positive slurry may range from 1 wt % to 5 wt % of the positive active material.

The preparation method of the negative plate 23 may be the same as that of the positive plate 22. The coated area 23a of the negative plate 23 may be formed by uniformly coating a negative slurry onto a negative current collecting portion; and the uncoated area 23b of the negative plate 23 may be formed by reserving a blank area with a certain width before coating or removing the coated material with a certain width along a width direction of the negative plate 23. The uncoated area 23b may serve as a negative tab, and the negative tab may have the same length of the negative plate 23.

There is no special limit for the material of the negative slurry. The negative slurry may comprise a negative active material, a binding agent, a solvent and optionally a conductive agent. The negative active material may be chosen from any kind of conventional negative active material used in the art. According to some embodiments of the disclosure, the negative active material may include one or more selected from non-graphitic carbon, graphite or carbon formed by high temperature oxidation of polyalkynes polymeric materials. According to some embodiments of the disclosure, the negative active material may include one or more selected from pyrolytic carbon, coke, sinter of organic polymers, activated carbon and other carbon materials. The sinter of organic polymers may be prepared by first sintering polymers like phenolic resins and epoxy resins, and then carbonizing the sintered polymers.

The negative slurry may optionally comprise a conductive agent known in the art. According to some embodiments, the conductive agent may include one or more selected from conductive carbon black, nickel powders and copper powders. And the content of the conductive agent may range from 0.1 wt % to 12 wt % of the total weight of the negative slurry.

The solvent for the positive slurry and the negative slurry may include conventional solvents known in the field. According to some embodiments, it may include one or more selected from N-methyl-2-pyrrolidone (NMP), N,N-dimethyl formamide (DMF), N,N-diethyl formamide (DEF), dimethyl sulfoxide (DMSO), tetrahydrofuran (THF), water and alcohols. The dosage of the solvent may satisfy that enough slurry can be coated onto the current collecting portions. According to some embodiments, the dosage of the solvent may satisfy that the concentration of the positive active material ranges from about 40 wt % to 90 wt % in the slurry. According to some preferred embodiments, the concentration of the positive active material may range from 50 wt % 85 wt % in the slurry.

The preparation method of the positive plate 22 and the negative plate 23 may be any methods known in the art.

According to some embodiments of the present disclosure, the battery comprises a non-aqueous electrolyte. The non-aqueous electrolyte may be a solution formed by dissolving electrolyte lithium salts into a non-aqueous solvent. According to some embodiments, the electrolyte lithium salt may include one or more selected from lithium hexafluorophosphate (LiPF₆), lithium perchlorate (LiClO₄), lithium tetrafluoroborate (LiBF₄), lithium hexafluoroarsenate (LiAsF₆), lithium hexafluorosilicate (LiSiF₆), lithium tetraphenylborate (LiB(C₆H₅)₄), lithium chloride (LiCl), lithium bromide (LiBr), lithium tetrachloroaluminate (LiAlCl₄), lithium trifluoromethylsulfonate (LiC(SO₂CF₃)₃), LiCH₃SO₃ and LiN(SO₂CF₃)₂. The non-aqueous solvent may include a mixture of catenary acid esters and cyclic acid esters. The catenary acid ester may include one or more selected from dimethyl carbonate (DMC), diethyl carbonate (DEC), methyl ethyl carbonate (EMC), methyl propyl carbonate (MPC), dipropyl carbonate (DPC) and other fluorine-containing, sulfur-containing or unsaturated bond-containing catenary organic esters. The cyclic organic ester may include one or more selected from ethylene carbonate (EC), propenyl carbonate (PC), vinylene carbonate (VC), γ-butyrolactone (γ-BL), sultone and other fluorine-containing, sulfur-containing or unsaturated bond-containing cyclic organic esters. In the non-aqueous electrolyte solution, the concentration of the electrolyte lithium salt may range from about 0.1 mol/L to 2 mol/L; according to a preferred embodiment, it may range from about 0.8 mol/L to 1.2 mol/L.

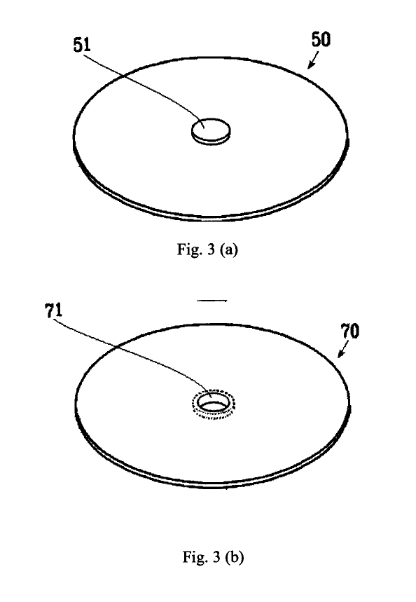

As shown in FIG. 1, FIG. 3(a) and FIG. 3(b), according to some embodiments, the current collecting plates may comprise the first current collecting plate 70 located at the lower end of the electrode assembly 20 and a second current collecting plate 50 located at the upper end of the electrode assembly 20. The first current collecting plate 70 may be electrically connected with the battery shell 11. The battery shell 11 may serve as a negative terminal. The second current collecting plate 50 may be connected with the cover assembly 30 via a connecting strip 40. According to an embodiment of the disclosure, the shape of the current collecting plate may be selected according to the shape of the battery shell 11. For prismatic batteries, square current collecting plates may be selected. For cylindrical batteries, circular current collecting plates may be selected. FIG. 3(a) and FIG. 3(b) show a circular current collecting plate. According to a preferred embodiment, the second current collecting plate 50 may be made of aluminum while the first current collecting plate 70 may be made of copper. In this case, the electrical connection between the electrode plates and the current collecting plates may be enhanced accordingly.

According to the present disclosure, the core rod 24 may be optional. According to an embodiment of the present disclosure as shown in FIG. 1, the core rod 24 is adopted. According to a preferred embodiment, a round protruding part may be formed in the center of the current collecting plates. The protruding part may form a round protruding boss on the surface of the current collecting plates. As shown in FIG. 3(a), a round boss 51 protruding upwards is formed on the second current collecting plate 50 so that a round concave in the opposite direction may accommodate an end of the core rod 24. FIG. 3(b) shows that the first current collecting 70 may have a round boss 71 protruding downwards. The second current collecting plate 50 may be connected with a cover board 34 of the cover assembly 30 via the connection between the connecting strip 40 and the boss 51. The round boss 71 of the first current collecting plate may be in contact with the battery shell 11 and fixed by resistance welding. According to an embodiment shown in FIG. 1, an insulating pad 60 may be set underneath the first current collecting plate 70. The insulating pad 60 may be formed with an aperture in the center. The round boss 71 of the first current collecting plate 70 may be electrically connected with the bottom of the battery shell 11 via the aperture.

The current collecting plates 50, 70 and the end faces of the electrode assembly 20 may be welded to form an end face structure for current collecting. According to some embodiments of the present disclosure, full penetration laser welding may be used. A welding spot 22c is formed where the end face of the uncoated area 22b of the positive plate 22 is jointed with the second current collecting plate 50. And a welding spot 23c is formed where the end face of the uncoated area 23b of the negative electrode 23 is jointed with the first current collecting plate 70. During welding, the focus of the laser beam may be adjusted to control the diameter of the welding spot. According to some preferred embodiments, the diameter of the welding spot may range from 0.5 to 1.2 times of the thickness of the current collecting plate. If the diameter of the welding spot is too small, it may affect the conducting area and welding strength of the current collecting plate, whereas if the diameter of the welding spot is too large, the laser beam may easily penetrate through the end face of the electrode assembly 20, damaging the coating areas of the electrode plates in a direct or reflective manner.

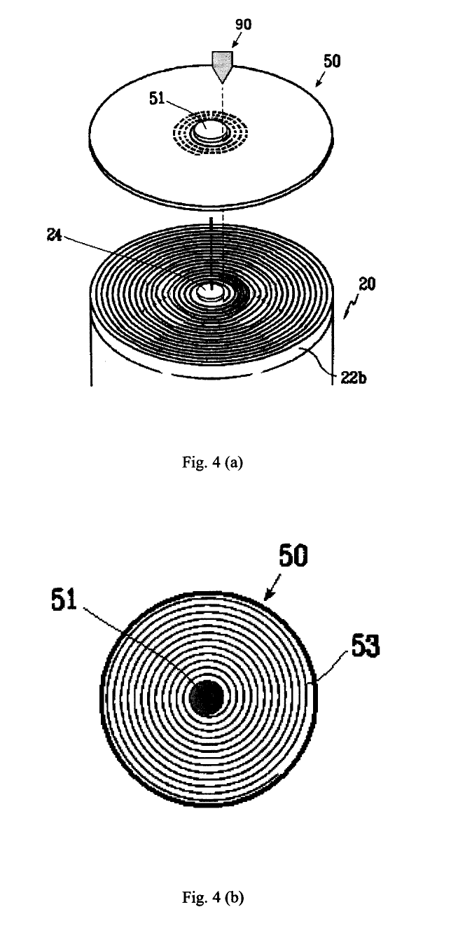

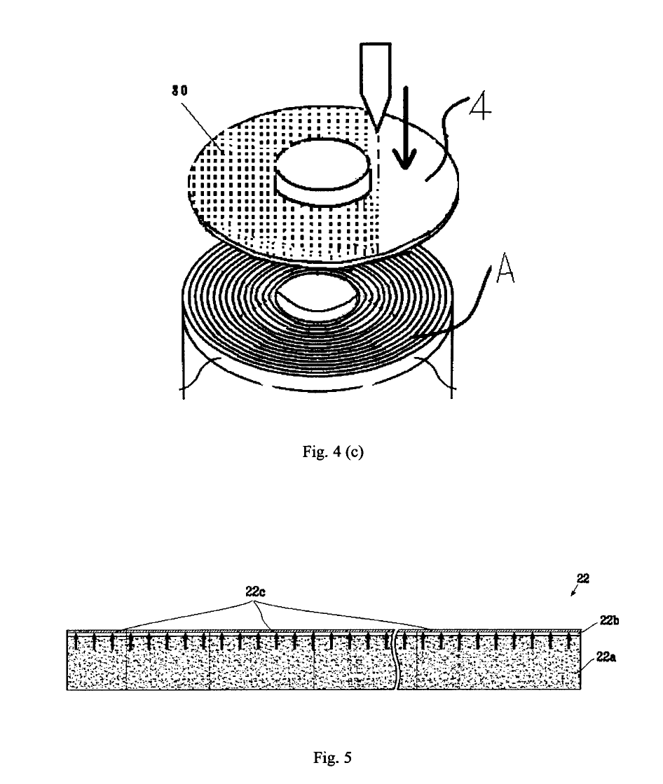

Taking a cylindrical lithium ion battery as an example, the trace line of the laser beam during end face welding (referred to as “welding trace pattern” as follows) may be calculated based on the diameter of the electrode assembly 20, the thickness of the electrode plates 50, 70 and the starting point of coiling. The laser beam may weld according to any type of trace lines during welding, for example, linear welding trace lines in parallel with each other along a diameter direction, or spiral welding trance lines along the coiling trace line of the electrode assembly 20. According to an embodiment shown in FIG. 4(a), to ensure the alignment of the laser beam welding trace and the end surface of the electrode assembly 20, a micro-spur camera may be adopted to photograph the end face of the electrode assembly 20. The laser beam welding trace may be further adjusted according to the obtained video of the end face of the electrode assembly 20, and then a laser head 90 may weld the second current collecting plate 50 and the electrode assembly 20 according to an obtained welding trace 53. FIG. 4(b) shows a top view of a welded trace pattern 53 according to an embodiment of the invention. The welding trace pattern 53 is formed on the second current collecting plate 50. The welding method of the end face may not be limited to cylindrical batteries. According to an embodiment shown in FIG. 4(c) in which linear scan welding is adopted, welding trace lines 80 between the uncoated area 22b and the current collecting plate 50 are linear lines in parallel with each other in a plane perpendicular to the height, i.e. longitudinal, direction of the battery.

According to the embodiment described above, the end-face welding may provide a sufficient contact between the end face of the electrode assembly 20 and the current collecting plates. FIG. 5 shows a current collecting effect of the positive plate 22. From FIG. 5, the current collection is uniform. The laser beam may weld continuously or at an interval, or even at a random interval. According to a preferred embodiment, to obtain better current collecting efficiency of the battery, continuous welding may be adopted.

According to the present disclosure, as the contact surfaces between the current collecting plates 50, 70 and the electrode assembly 20 may be increased, the contact resistance thereof may be reduced, thus enhancing the current collecting efficiency.

As shown in FIG. 1, the cover assembly 30 may comprise a cover board 34, a positive terminal 31 overlapping with the cover board 34, a sealing and insulating member 32, and a rubber ball 33. The rubber ball 33 may be interposed between the cover board 34 and the positive terminal 31. The sealing and insulating member 32 may fit around the cover board 34 and the positive terminal 31 so that the cover board 34, the positive terminal 31, the rubber ball 33 and the sealing and insulating member 32 may be integrally fixed in the battery shell 11. Because of the sealing and insulating member 32, the positive terminal 31 may be insulated from the battery shell 11 which serves as the negative terminal. The positive terminal 31 may be electrically connected with the cover board 34, and the second current collecting plate 70 may be electrically connected with the cover board 34 via the connecting strip 40.

Battery preparation will be described as follows: first preparing an electrode assembly 20, and then laser welding the first current collecting plate 70 with the end face of the negative tab of the electrode assembly 20; placing the above welded product into the battery shell 11; placing the second current collecting plate 50 into the battery shell 11, and then laser welding the positive tab with the second current collecting plate 50 which contact perpendicularly to each other; then welding a connecting strip 40 on the second current collecting plate 50; further welding the connecting strip 40 onto the cover board 34 of the cover assembly 30; then welding the first current collecting plate 70 with the bottom of the battery shell 11; and after injecting the electrolyte, laying aside and sealing, the lithium ion battery may be finally obtained.

Although explanatory embodiments have been shown and described, it would be appreciated by those skilled in the art that changes, alternatives, and modifications all falling into the scope of the claims and their equivalents can be made in the embodiments without departing from spirit and principles of the invention.

What is claimed is:

1. A lithium ion battery comprising
a battery shell;
a cover assembly for sealing an open end of the battery shell;
an electrode assembly comprising a positive plate, a negative plate and a separator in between, the positive plate comprising a first coated area and a first uncoated area adjoining the first coated area along a longitudinal direction of the battery, and the negative plate comprising a second coated area and a second uncoated area adjoining the second coated area along the longitudinal direction of the battery with the second uncoated area opposing to the first uncoated area;
a first current collecting plate; and
a second current collecting plate, wherein
the electrode assembly and the current collecting plates are disposed in a space formed by the battery shell and the cover assembly, and the first and second current collecting plates are disposed at each end of the electrode assembly respectively, with the first uncoated area and second uncoated areas being welded to the first and second current collecting plates respectively.

2. The lithium ion battery according to claim 1, further comprising a core rod inserted in the center of the electrode assembly along the longitudinal direction of the battery.

3. The lithium ion battery according to claim 2, wherein the first and second current collecting plates are formed with a first concave and a second concave to accommodate each end of the core rod respectively.

4. The lithium ion battery according to claim 1, wherein the first and second uncoated areas have a width ranging from about 2 mm to 10 mm respectively in the longitudinal direction of the battery.

5. The lithium ion battery according to claim 4, wherein the first and second uncoated areas have a width ranging from about 3 mm to 5 mm respectively in the longitudinal direction of the battery.

6. The lithium ion battery according to claim 1, wherein welding trace lines between the first and second uncoated areas and the first and second current collecting plates are coiled trace lines in a plane perpendicular to the longitudinal direction of the battery.

7. The lithium ion battery according to claim 1, wherein welding trace lines between the first and second uncoated areas and the first and second current collecting plates are linear trace lines in parallel with each other in a plane perpendicular to the longitudinal direction of the battery.

8. The lithium ion battery according to claim 1, wherein diameters of welding spots where the first and second uncoated areas are welded to the first and second current collecting plates range from 0.5 to 1.2 times of a thickness of the first and second current collecting plates respectively.

9. The lithium ion battery according to claim 1, wherein both sides of adjoining areas between the coated area and the uncoated area are attached with adhesive tapes.

10. The lithium ion battery according to claim 1, wherein both sides of the first and second uncoated areas are adhered with adhesive tapes, the adhesive tapes having a width not larger than those of the first and second uncoated areas respectively in the longitudinal direction of the battery, with lower edges of the tapes being adhered to a border between the coated and uncoated areas.

11. The lithium ion battery according to claim 1, wherein the cover assembly comprises:
a cover board;
a positive terminal overlapping with the cover board;
a sealing and insulating member surrounding edges of the cover board and the positive terminal; and
a rubber ball interposed between the cover board and the positive terminal.

12. The lithium ion battery according to claim 1, wherein the first uncoated area and second uncoated areas are end-face welded to the first and second current collecting plates respectively.

13. The lithium ion battery according to claim 1, wherein the first and second uncoated areas serve as a positive tab and a negative tab respectively.

14. The lithium ion battery according to claim 1, wherein the first coated area is formed by uniformly coating a positive slurry on the positive plate, the positive slurry comprising a positive active material, a first binding agent and a first solvent.

15. The lithium ion battery according to claim 1, wherein the second coated area is formed by uniformly coating a negative slurry on the negative plate, the negative slurry comprising a negative active material, a second binding agent, a second solvent and optionally a conductive agent.

16. The lithium ion battery according to claim 1, further comprising a non-aqueous electrolyte.

17. The lithium ion battery according to claim 1, wherein the first current collecting plate is electrically connected with the battery shell, with the battery shell serving as a negative terminal.

18. The lithium ion battery according to claim 17, wherein an insulating pad formed with an aperture is disposed between the first current collecting plate and the battery shell, with the first current collecting plate electrically connected with the battery shell via the aperture.

19. The lithium ion battery according to claim 1, wherein the second current collecting plate is connected with the cover assembly.

20. A lithium ion battery comprising
an electrode assembly comprising a positive plate, a negative plate and a separator in between, the positive plate comprising a first coated area and a first uncoated area adjoining the first coated area along a longitudinal direction of the battery, and the negative plate comprising a second coated area and a second uncoated area adjoining the second coated area along the longitudinal direction of the battery with the second uncoated area opposing to the first uncoated area;
a first current collecting plate; and
a second current collecting plate, wherein
the first and second current collecting plates are disposed at each end of the electrode assembly respectively, with the first uncoated area and second uncoated areas being welded to the first and second current collecting plates respectively.
